(19) United States
(12) Patent Application Publication
(10) Pub. No.: US 2004/0041839 A1
(43) Pub. Date: Mar. 4, 2004

(54) Method and apparatus for electronically managing, manufacturing, and testing of a medical device in accordance with a set of regulatory provisions

(76) Inventors: Claude Scher, Milwaukee, WI (US); Lawrence A. Levine, Waukesha, WI (US)

Correspondence Address: ZIOLKOWSKI PATENT SOLUTIONS GROUP, LLC (GEMS), 14135 NORTH CEDARBURG ROAD, MEQUON, WI, 53097, US

(21) Appl. No.: 10/264,952

(22) Filed: Oct. 4, 2002

Related U.S. Application Data
(60) Provisional application No. 60/408,109, filed on Sep. 3, 2002.

(51) Int. Cl. G09G 5/00

(52) U.S. Cl. 345/772

(57) ABSTRACT

The present invention is directed to a method and apparatus of managing and maintaining data associated with the manufacturing and/or testing of a device. Specifically, the present invention provides a GUI that displays digitized work instructions for service technicians and engineers associated with the manufacturing and/or testing of the device. Moreover, the present invention includes a platform whereby historical data associated with the manufacturing and testing of a device is digitally maintained and automatically collected upon the testing of a device. By incorporating authenticated input associated with changes in the manufacturing and/or testing process as well as data associated with the actual manufacturing and/or testing of the data, the present invention manages the manufacturing and/or testing of a device in accordance with strict regulatory concerns.

### CROSS REFERENCE TO RELATED APPLICATIONS

The present application is a non-provisional and claims priority of provisional U.S. Ser. No. 60/408,109 filed Sep. 3, 2002.

### BACKGROUND OF INVENTION

The present invention relates generally to manufacturing and testing of medical equipment and, more particularly, to a method and apparatus for electronically managing the manufacture and testing of a device in accordance with strict regulatory provisions.

During the manufacturing and testing of a device, assemblers, technicians, engineers, and the like typically use a set of instructions on how to assemble and test a product. These work instructions must be revision-controlled and easily accessible to the technicians as well as the support engineers who are responsible for updating the work instructions during the manufacturing and testing of the device. To ensure that the device is assembled and/or tested in accordance with regulatory provisions, there must a strict discipline with regard to maintaining and deploying the work instructions. This is particularly true during the manufacturing and testing of medical equipment that must be manufactured and tested in accordance with strict guidelines set forth by the Food and Drug Administration. Thus, there is a need to develop a platform by which digitized work instructions are maintained through a regulatory compliant tool that can enforce rules regarding the maintenance, updating, and accessing of the work instructions.

During the assembling and/or testing of a device, device history records are corrected and maintained. A number of issues surround the collection and authentication of paper device history records. Specifically, the use of paper based device history records are susceptible to completion of a device history record without proper authorization, falsified signature or outdated information, misplacement or accidental destruction, as well as, issues surrounding maintaining the voluminous device history records often associated with manufacturing and testing a complex device such as an imaging scanner. Therefore, there is need to manage and maintain the collection of data for device history records that helps ensure the authentication of data as well as comply with regulatory provisions.

As indicated previously, maintenance and collection of device history records may be prone to error especially when maintaining and collecting voluminous device history records. These concerns are magnified when considering the extent of data and information often associated with each device history record. For example, when completing a device history record associated with a particular test of the device, test data must be collected from the device and included in the device history record. Not only is the importation of test data from the device to a device history record time-consuming but is also prone to errors considering the extent and complexity of the test data. Moreover, with the manual completion and updating of a device history record associated with a test of the device, it is imperative that a technician or engineer be cognizant that a test has, in fact, been completed. If a test of the device is run and a device history record is not completed or updated as a result of that test, regulatory provisions may have been violated. Thus, there is a need to automatically detect and verify that a test has been run in accordance with regulatory provisions, as well as automatically collect testing data from the device and import that data to a device history record.

Therefore, it would be desirable to design an electronic manufacturing and testing tool that facilitates the maintenance as well as compliance of manufacturing and/or testing instructions associated with the device as well as provide a system whereby data associated with the actual manufacturing and testing of the device is efficiently, systematically, and precisely maintained in accordance with regulatory provisions.

### SUMMARY OF INVENTION

The present invention is directed to a method and apparatus of managing and maintaining data associated with the manufacturing and/or testing of a device overcoming the aforementioned drawbacks. Specifically, the present invention provides a graphical user interface (GUI) that displays digitized work instructions for service technicians and engineers associated with the manufacturing and/or testing of the device. Moreover, the present invention includes a system whereby historical data associated with the manufacturing and testing of a device is digitally maintained and automatically collected upon the testing of a device or a user input. By incorporating authenticated input associated with changes in the manufacturing and/or testing process as well as data associated with the actual manufacturing and/or testing of the data, the present invention manages the manufacturing and/or testing of a device in accordance with strict regulatory concerns.

Therefore, in accordance with one aspect of the present invention, a method of coordinating the manufacturing and testing of a device is provided. The method includes the step of determining a series of tasks for at least one of manufacturing and testing a device. The method further includes the steps of developing a master device history record and integrating the series of tasks and the master device history record into a GUI that is accessible by one or more persons responsible for manufacturing and/or testing the device. The method also includes automatically updating a task and the master device history record based on an authorized input to the GUI.

In accordance with another aspect of the present invention, a system for a manufacturing device in accordance with a set of regulatory provisions includes at least one assembly station and at least one testing station. The system also includes at least one user station positioned proximate to the at least one assembly station and the at least one testing station wherein the at least one user station includes a monitor configured to display a GUI. A main station is also provided remotely from the at least one assembly station and the at least one testing station wherein the main station is networked with the at least one user station. The main station includes a processor configured to display a GUI on each user station user monitor as well as populate the GUI with a number of markers identifying a status of assembling a device. The processor is further configured to detect a user input identifying completion of a task associated with assembling of the device and authenticate the user based on the set of regulatory provisions. If the user is authenticated, the processor updates the number of markers to reflect on the GUI process toward completion of the assembling of the device.

In accordance with yet another aspect of the present invention, a computer data signal embodied in a carrier wave and representing a sequence of instructions is provided that when executed by a processor causes the processor to display a number of markers wherein each marker indicates the status of a task associated with at least one of manufacturing and testing a device. The sequence of instructions then causes the processor to display a master history record for the device and update the marker and the device history record upon completion of a task only if data indicating completion of the task is certified in accordance with a set of regulatory provisions.

Various other features, objects and advantages of the present invention will be made apparent from the following detailed description and the drawings.

### BRIEF DESCRIPTION OF DRAWINGS

The drawings illustrate one preferred embodiment presently contemplated for carrying out the invention.

In the drawings:

FIG. 1 is a schematic block diagram of an integrated manufacturing and/or testing system for use with the present invention.

FIG. 2 is a schematic block diagram setting forth several communication paths communication in accordance with the present invention.

### DETAILED DESCRIPTION

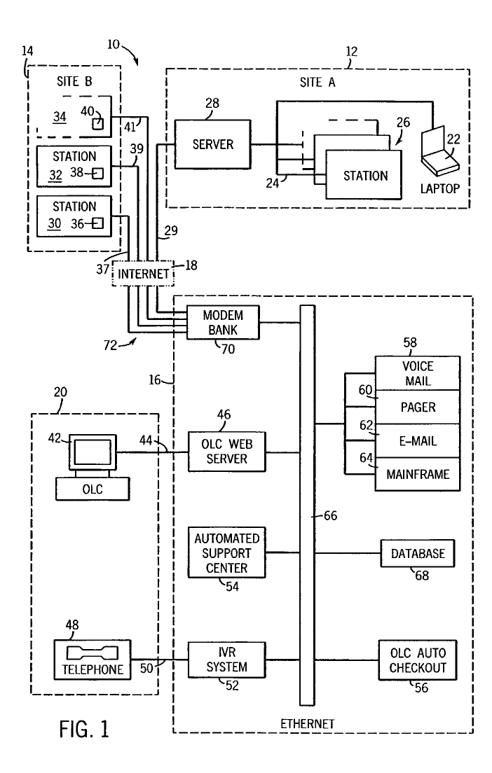

Referring to FIG. 1, an overview block diagram of an integrated networked manufacturing and/or testing system 10 is shown which includes a plurality of manufacturing and/or testing sites, such as Testing Site 12, and Manufacturing Site 14. It is understood, that the number of sites can be limitless located in separate, remote facilities, or housed within a single facility. Each site is sufficiently constructed to facilitate production and/or testing of a device. The sites 12, 14 are connected to a centralized facility or main station 16 through a communications link, such as a network of interconnected server nodes 18 or a remote link 20. The centralized facility may be located in the same facility as either site or remotely located from each. Although a single centralized facility is shown and described, it is understood that the present invention contemplates the use of multiple centralized facilities, each capable of communication with each site.

The various sites disclosed are configured to be selectively linked to the centralized facility 16 by either the remote link 20, or in the example of site 12, a user station 22 such as a laptop computer connected to an internal network of user stations 24. Such selective linking is desirable for managing and monitoring the testing and/or assembling of devices or components thereof, which includes accessing data regarding completion of a task associated with manufacturing and/or testing device such as a user input or the auto-detecting of a test and the subsequent transference of test data.

In general, a site may have a number of stations for manufacturing and/or testing devices such as medical diagnostic systems of various modalities. User station 22 may be connected to a number of networked stations 26 via an internal network 24 served by a server. Alternately, as shown with regard to site 14, each site can include a number of non-networked stations 30, 32, and 34 each having a computer or workstation 36, 38, 40 associated therewith and having an internal modem to connect the station to a communications link, such as the Internet 18 through links 37, 39, and 41, respectively, to communicate with the centralized facility 16. Internet 18 is shown in phantom to indicate that an external communications network can include Internet 18, together with communication links 29, 37, 39, and 41, or alternatively, can include direct dial-up links through dedicated lines, an intranet, or public communications systems.

It is understood that each of the network stations may include its own workstation for individual operation and are linked together by the internal network 24 so that an operator such as a technician or engineer can centrally manage each of the stations. Further, such a system is provided with communications components allowing it to send and receive data over a communications link 29. Similarly, for the non-networked stations at site 14, each of the user stations 30, 32, and 34 communicate with the centralized facility via communications links 37, 39, and 41, respectively. Although FIG. 1 shows each of these links connected through an open network 18, these links can permit data to be transferred to and from the systems over a dedicated network as well.

The embodiment shown in FIG. 1 contemplates a facility for manufacturing and testing systems as magnetic resonance imaging (MRI) systems, ultrasound systems, x-ray systems, computed tomography (CT) systems, as well as positron emission tomography (PET) systems, or any other type of medical imaging system or component thereof, however, the present invention is not so limited and may be implemented with the manufacturing and testing of a device that must be assembled and tested in accordance with stringent regulations. In the embodiment shown in FIG. 1, each site station 12, 14 can include any combination of the aforementioned stations, or a site may have all of a single type of station. A site can also include a single manufacturing or testing station.

An input regarding completion of a task associated with manufacturing or testing of the device or an altering of the assembling/testing process in accordance with the present invention can be initiated by authorized personnel, such as an on-line engineer or technician from a computer or workstation 42 in the remote link 20, which can be a part of the centralized facility 16, or be separately connected to the centralized facility 16 by a dialup link 44 to a web server 46 in the centralized facility 16. Alternatively, it is contemplated that the system could be initialized by a laptop computer 22 connected to internal network 24, or individually connected to each of the stations 30, 32, or 34. The remote link 20 can also serve to connect the centralized facility 16 to a site by a telephone and telephone connection 48 through a conventional telephone network 50 and to an interactive voice recognition system (IVR) 52 in the centralized facility 16. The centralized facility 16 includes a number of processing systems including computers for the IVR system 52, an automated support center 54, the web server 46, and an auto checkout server 56, for processing station and device data and creating an appropriate configuration file. Other processor systems include computers to maintain a voicemail system 58, a pager system 60, an email system 62, and a main frame 64, and more generally, an output report generator and notifier. Each is connectable and can transmit data through a network, such as an Ethernet 66 with one another, and/or with at least one database 68. However, it is understood that the single representation of a database in FIG. 1 is for demonstrative purposes only, and it is assumed that there is a need for multiple databases in such a system. It is also understood that the IVR system is not only a voice recognition system, but can also process interactive keypad entry from a touchtone telephone 48. A bank of modems 70 is connected to the Ethernet 66 to relay data from the centralized facility 16 to the sites 12, 14 through a plurality of modem links 72.

As previously described, each of the sites and stations described herein and referenced in FIG. 1 may be linked selectively to the centralized facility 16 via a network 18. According to the present invention, any acceptable network may be employed whether public, open, dedicated, private, or so forth provided the network is capable of displaying a GUI on a user station monitor. The communications links to the network may be of any acceptable type, including conventional telephone lines, fiber optics, cable modem links, digital subscriber lines, wireless data transfer systems, or the like. Each of the stations is provided with communications interface hardware and software of generally known design, permitting them to establish network links and exchange data with the centralized facility 16. The systems are provided with interactive software so as to configure the systems and exchange data between the sites and the centralized facility 16. In some cases, during periods when no data is exchanged between the sites and the centralized facility, the network connection can be terminated. Preferably, however, the network connection is maintained continuously.

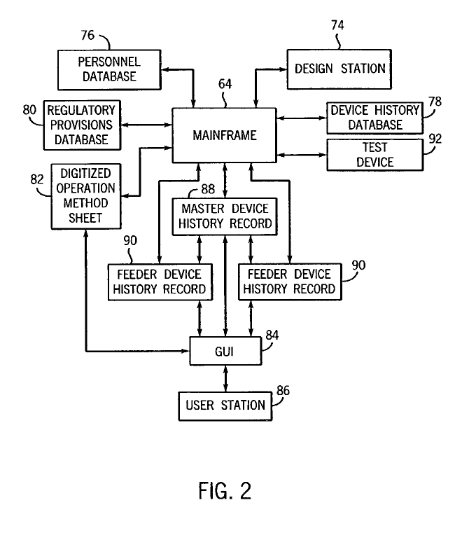

The present invention is directed to an integrated, digitized platform for disseminating work instructions and historical data regarding the manufacturing and/or testing of a device or a component thereof. Specifically, the platform allows for the display of work instructions or operational method sheets (OMSs) and historical data or device history records (DHRs) on a graphical user interface (GUI) that may be accessed from a computer over an Internet or other electronic communication. As will be described with respect to FIG. 2, the present invention includes several data communication lines such that up-to-date and compliant data is readily accessible and provideable through a GUI.

Referring to FIG. 2, the interrelationship and several communication lines to effectuate the providing, viewing, and certifying data associated with the manufacture and/or testing of a device or component thereof is shown. Once a design and/or process for the manufacturing and/or testing of a device is established, that information is provided to mainframe 64 or central processor from a design station 74. The design station 74, which may be located remotely located from the mainframe 64 housed in the centralized facility 16, may be connected to mainframe directly using a dedicated connection via a GUI that is displayed on the design station monitor. As such, when the design engineer begins to input initial or set-up data regarding the manufacturing and/or testing of a device, the mainframe may display a template designed to assist the engineer with the “setting-up” the manufacturing and/or testing platform.

Further, during the setup, mainframe 64 may access information from a personnel database 76 based on the team members identified during the set up. The personnel database 76 includes contact information as well as rights and privilege information regarding the manufacturing and/or testing of the device. That is, to be compliant with a set of regulatory provisions, regulations regarding the accessing and updating of data regarding the manufacturing and/or testing of a device must be followed and maintained. As such, personnel information setting forth the rights and privileges regarding access to data is maintained in a personnel database.

During the set up process mainframe 64 also accesses a DHR database 78 that maintains templates as well as actual historical data associated with a device, as will be described below. In setting up the manufacturing and/or platform, mainframe 64, based on a series of inputs by the platform initiator, will determine a DHR template appropriate to the device being assembled and/or tested. The DHR template will set forth that which is needed for initializing the manufacturing and/or testing of the device. Moreover, the DHR template is constructed to automatically comply with any regulatory provisions that must be taken into consideration during the manufacturing and/or testing process.

An updatable regulatory provisions database 80 is also provided and accessible by mainframe 64. Database 80 includes data associated with compliance with regulatory concerns regarding the manufacturing and/or testing of the device. Notwithstanding the DHR template which governs the initial input of data being compliant, mainframe 64 will actively compare the input data with the set of regulatory provisions stored on database 80 to ensure that the platform is being established is, in fact, compliant.

Once the platform for the manufacturing and/or testing of the device is established in accordance with any regulatory concerns, mainframe 64 compiles the data input by the user and generates a set of digital documents which are viewable electronically and remotely. For example, the mainframe is designed to display digitized OMSs on a GUI 84 such that authorized technicians and engineers involved in the manufacturing and/or testing process may readily access work instructions regarding the device from a user station 86. That is, the OMS may display an assembled image of the device, images illustrating each step of the assembly and/or testing process, a list of materials needed for the manufacturing and assembling process, as well as, historical data associated with that particular OMS.

The present invention allows for the updating of data relating to the manufacturing and/or testing process by any authorized user, provided the updated data complies with any regulatory concerns. As such, when a user such a technician or design engineer seeks to update an OMS, mainframe 64 will access databases 76 and 80 to determine if the user is authorized to make such a change and, if so, if the input complies with any regulatory concerns. As a result, an OMS that is regulatory compliant is consistently maintained.

In a further embodiment, a fully integrated manufacturing and/or testing platform is maintained. That is, mainframe 64 based on initial set up of the manufacturing and/or testing platform develops a master DHR 88. Master DHR 88 includes historical data associated with the particular device being manufactured and/or tested. For example, DHR 88 may include information regarding when a component or a particular test was completed, data regarding the person responsible for certifying completion, a set of status markers, and the like.

A plurality of feeder DHRs 90 may be developed by mainframe 64 during the set up process and selectively linked to the master DHR. The feeder DHRs 90 relate to a particular component to be manufactured and/or tested rather than the system as whole. As such, each feeder DHR operates similarly to the master DHR but is limited to the particular component. Like the master DHR, each feeder DHR includes data associated with completion of a particular task(s), those responsible for completing and/or certifying completion of the task(s), and the like. Moreover, each feeder DHR may have a plurality of feeder DHRs associated therewith. For example, in the context of a CT apparatus, a master DHR for the entire system is created and maintained having a number of feeder DHRs associated therewith for each system or component of the CT apparatus. One feeder DHR could be directed to the manufacturing and testing of the gantry. That feeder DHR could include a series of feeder DHRs associated with completion and/or testing of the components that comprise the gantry. This tree of DHRs could be extended as far as necessary to outline and efficiently manage the manufacturing and/or testing of the CT apparatus.

Moreover, each DHR regardless of level is viewable as GUI on a user station monitor and may be updated by an authorized user. An authorized user, for example, may input data indicating completion of the assembling of a particular component of the system directly to a feeder DHR. Once that input is certified in accordance with the set of regulatory provisions set forth in database 80, mainframe 64 will automatically update the feeder DHR which is stored on database 78 to reflect the change in data so that subsequent accessing of that DHR will indicate that the task has been completed. Further, mainframe 64 will automatically update any other DHRs associated with the feeder DHR that was updated. Those additional DHRs may include one or more parent feeder DHRs and the master DHR.

As previously described, the present invention includes a platform by which mainframe 64 detects that a device 92 has been tested in accordance with any regulatory concerns and, if the test was properly executed, automatically updates the device history database to include the test data. This linking to the tested device avoids an operator from having to manually enter the test data, which can be voluminous, directly to a DHR. Moreover, the present invention verifies that a test was compliantly executed so that unverified and/or uncertified data does not taint the DHR. Alternately, rather than the mainframe automatically detecting that a test has been executed, an operator could signal that a test was just executed as an input to GUI 84 by which the mainframe would then access the tested device, determine the compliance of the test, and upload the test data automatically. The mainframe would then automatically update database 78 to include the test data as well as automatically populate the master DHR and any related feeder DHR to indicate that the test has been compliantly executed and test data has been attained.

The present invention contemplates a number of mechanisms by which an operator and subsequent input is authenticated and verified including a dedicated username and password. However, many regulatory agencies require additional authentication measures such as an electronic signature. As such, each OMS and DHR may not be updated or amended unless the input effectuating the change is electronically signed in accordance with mandated regulations. By having each OMS and DHR template from which an actual OMS or DHR is developed audited to satisfy any regulatory concerns together with the electronic signature requirements, the present invention provides a fully compliant regulatory tool for manufacturing and/or testing a device. Furthermore, by addressing any regulatory concerns at the outset, resources required for ensuring regulatory compliance during the manufacturing and/or testing process may be directed elsewhere.

Additionally, by limiting access to the an OMSs and a DHRs so that only those individuals involved in the manufacturing and/or testing of the device, managing the manufacturing and/or testing in a regulatory compliant manner may be better achieved. That is, an individual trained to design, assemble, or test one type of device would be prevented from authorizing a change to the OMS or input data to the DHR of another device for which that individual is not trained. As such, the integrity of the manufacturing and/or testing process is maintained.

As was described with respect to FIG. 1, the present invention contemplates an environment by which a manufacturing site may be remotely located from a testing site and vice-versa. Furthermore, the present invention contemplates multiple manufacturing and/or testing sites that are remote from each other. For example, one manufacturing site may be located in one country and another manufacturing site would be located in another country. The present invention maintains the integrity of the complete manufacturing and/or testing process by digitizing the OMSs and DHRs to be electronically accessible using a GUI and connecting each site through an integrated and secure network. As such, any authorized changes to the process or executed tests and the corresponding test data may be readily accessed and viewed from any user station accessible to the mainframe.

The present invention also includes real-time status indicators that provide a current, up-to-date, real-time indication of progress toward completion of the manufacturing and/or testing process or any step thereof. That is, each GUI includes representative markers indicating a status of the process. For example, the master DHR GUI may include markers indicating a completion status of the tasks of the project as a whole. Each feeder DHR GUI may include markers indicating a completion status of the tasks associated with that feeder DHR. As a result, a stage of the manufacturing and/or testing process may be readily identified.

Preferably, each GUI also includes various hyperlinks to additional information regarding the device. For example, links to personnel information, team organization, team leader, device design history, test history, and regulatory provisions would be included. A link to a help menu is also provided to provide assistance with the input and certification of data or other concerns related to the information displayed on the GUI.

The present invention also provides for the generation of auditing and other reports directly though a GUI thereby eliminating the need to compile the necessary data and generate the report separately. That is, a report template database may be maintained such that mainframe 64 based on an identifying input by a user generates and populates the appropriate report template for generation of the requested report. As such, a report may be generated remotely and without direct access to the data.

Therefore, in accordance with one embodiment of the present invention, a method of coordinating the manufacturing and testing of a device is provided. The method includes the step of determining a series of tasks for at least one of manufacturing and testing a device. The method further includes the steps of developing a master device history record and integrating the series of tasks and the master device history record into a GUI that is accessible by one or more persons responsible for manufacturing and/or testing the device. The method also includes automatically updating a task and the master device history record based on an authorized input to the GUI.

In accordance with another embodiment of the present invention, a system for a manufacturing device in accordance with a set of regulatory provisions includes at least one assembly station and at least one testing station. The system also includes at least one user station positioned proximate to the at least one assembly station and the at least one testing station wherein the at least one user station includes a monitor configured to display a GUI. A main station is also provided remotely from the at least one assembly station and the at least one testing station wherein the main station is networked with the at least one user station. The main station includes a processor configured to display a GUI on each user station user monitor as well as populate the GUI with a number of markers identifying a status of assembling a device. The processor is further configured to detect a user input identifying completion of a task associated with assembling of the device and authenticate the user based on the set of regulatory provisions. If the user is authenticated, the processor updates the number of markers to reflect on the GUI process toward completion of the assembling of the device.

In accordance with yet another embodiment of the present invention, a computer data signal embodied in a carrier wave and representing a sequence of instructions is provided that when executed by a processor causes the processor to display a number of markers wherein each marker indicates the status of a task associated with at least one of manufacturing and testing a device. The sequence of instructions then causes the processor to display a master history record for the device and update the marker and the device history record upon completion of a task only if data indicating completion of the task is certified in accordance with a set of regulatory provisions.

The present invention has been described in terms of the preferred embodiment, and it is recognized that equivalents, alternatives, and modifications, aside from those expressly stated, are possible and within the scope of the appending claims.

What is claimed is:

1. A method of coordinating the manufacture and testing of a device, the method comprising the steps of:
determining a series of tasks for at least one of manufacturing and testing a device;
developing a master device history record integrating the series of tasks and the master device history record into a GUI and accessible by one or more persons responsible for the at least one of manufacturing and testing of the device; and
automatically updating a particular task and the master device history record based on an authorized input to the GUI.

2. The method of claim 2 further comprising the step of automatically updating only if the input complies with a set of regulatory provisions.

3. The method of claim 2 further comprising the determining compliance of the input based on an electronic signature of a user responsible for the input.

4. The method of claim 1 further comprising the step of displaying a real-time status of the series of tasks on the GUI.

5. The method of claim 4 further comprising the step of providing a portal incorporated into the GUI to allow the one or more persons to input data related to completion of a particular task.

6. The method of claim 5 further comprising the step of allowing the one or more persons to navigate the GUI only if the one or more persons are authorized to mavigate the GUI.

7. The method of claim 1 further comprising the step of automatically detecting testing of the device.

8. The method of claim 7 further comprising the steps of uploading testing data from the device and automatically updating the device history record with the uploaded testing data.

9. A system for manufacturing/testing a device in accordance with a set of regulatory provisions, the system comprising:
at least one assembly station and at least one testing station;
at least one user station positioned proximate to the at least one assembly and the at least one testing station, the at least one user station having a monitor configured to display at least a GUI; and
a main station remote from the at least one assembly station and the at least one testing station, the centralized facility networked with the at least one user station, and having a processor configured to:
display a GUI on each user station monitor;
populate the GUI with a number of markers identifying a status of a series of tasks associated with at least one of manufacturing and testing a device;
detect a user input identifying completion of a task associated with at least one of manufacturing and testing of the device;
authenticate the user based on a set of regulatory provisions; and if the user is authenticated
update the number of markers to reflect on the GUI completion of the task.

10. The system of claim 9 wherein the processor is further configured to generate a master device history record for the device and display the master device history record on the GUI.

11. The system of claim 10 wherein the processor is further configured to generate the master device history record from more than one feeder device history record, wherein each feeder device history record contains data associated with one of manufacturing and testing a component of the device.

12. The system of claim 11 wherein the processor is further configured to automatically update the master device history record upon input of data to a feeder device history record.

13. The system of claim 11 wherein the centralized facility is connected to a device to be tested and wherein the processor is further configured to detect a testing of the device and automatically update the master device history record with test data uploaded directly from the device.

14. The system of claim 9 wherein the processor is further configured to provide a real-time status of the series of tasks associated with assembling the device.

15. The system of claim 9 wherein the processor is further configured to authenticate the user input based on an electronic signature that complies with the set of regulatory provisions.

16. A computer data signal embodied in a carrier wave and representing a sequence of instructions that when executed by a processor causes the processor to:
display a number of markers, each marker indicating a status of a task associated with at least one of manufacturing and testing a device;
display a master device history record for the device; and
update a marker and the device history record upon completion of a task only if data indicating completion of the task is certified in accordance with a set of regulatory provisions.

17. The computer data signal of claim 16 wherein the sequence of instructions further causes the processor to display one or more feeder device history records, wherein each device history record is associated with a particular component of the device.

18. The computer data signal of claim 17 wherein the sequence of instructions further causes the processor to update a feeder device history record upon completion of a task associated with the component.

19. The computer data signal of claim 17 wherein the sequence of instructions further causes the computer to detect a test of a device and automatically update the master device history record with test data from the device.

20. The computer data signal of claim 17 wherein the sequence of instructions further causes the processor to display a series of steps for a process of assembling the device.

21. The computer data signal claim 17 wherein the sequence of instructions further causes the processor to detect a proposed change to a step of the process upon certification of the proposed change in accordance with the set of regulatory provisions.
